(19) United States
(12) Patent Application Publication
(10) Pub. No.: US 2013/0110879 A1
(43) Pub. Date: May 2, 2013

(54) DECLARATIVE SUPPORT FOR REFERENCE DATA IN RELATIONAL DATABASES

(71) Applicants: Fabian O. Winternitz, Kirkland, WA (US); William E. Gibson, Woodinville, WA (US); Yang Gao, Redmond, WA (US); Haroon Ahmed, Bellevue, WA (US)

(72) Inventors: Fabian O. Winternitz, Kirkland, WA (US); William E. Gibson, Woodinville, WA (US); Yang Gao, Redmond, WA (US); Haroon Ahmed, Bellevue, WA (US)

(73) Assignee: MICROSOFT CORPORATION, Redmond, WA (US)

(21) Appl. No.: 13/283,625

(22) Filed: Oct. 28, 2011

(51) Int. Cl. G06F 17/30

(52) U.S. Cl. 707/792; 707/E17.045

(57) ABSTRACT

Reference data is defined declaratively and deployed imperatively to both new and existing databases. By designating a reference data set as open or closed, reference data can be overwritten or spared. Reference data can be included in schema comparison. Reference data defined in scripts can be validated against corresponding table definitions and non-compliant values can be reported.

### BACKGROUND

Most databases have some dependence on reference data. Reference data is data content that rarely changes. Examples of reference data include pre-defined codes, such as United States state codes, currency or language codes and pre-defined data and process states. Reference data is typically deployed with the initial database deployment along with the database definition, in part, because applications often depend on the presence of the reference data to run. When reference data values are updated, they are updated the way the database content is updated.

Managing data content in a database usually means writing and executing imperative scripts or merge scripts. An imperative script inserts, updates and possibly deletes data content in the database. Imperative scripts are relatively efficient. Only data content that has actually changed is scripted and applied to the database. The script author has to be aware of the current state of the database in order to create the script so an imperative script cannot be written in advance unless the database state is known. Because the script varies depending on the state of the database, the script itself cannot be treated as part of the database definition.

A merge script merges a set of data values with those in the database. A merge script is more complex to write. While a merge script is declarative in nature, it is relatively inefficient because a merge script processes all the data values in the set regardless of the values that already exist in the database. A merge script relies on the database engine to merge the data values in the merge set with the current data content of the table. A merge script appears to change the database even if there is no actual change to the data values, which can impact management of the database.

### SUMMARY

A single (common) data definition for reference data can be used during both initial deployment of a database and incremental re-deployment of an existing database, making it easier to manage reference data during development and helping to ensure that reference data in a deployed database is complete and accurate. Reference data can be defined declaratively but deployed imperatively. A generated script can allow the reference data to be deployed to both new and existing databases. A reference data table can be designated closed or open. If designated as closed, the generated script can delete any values present in the database but not included in the declarative reference data definition. If designated as open, the generated script can ensure the defined values exist but refrain from deleting additional values. Reference data can be included in schema comparison. Reference data can be extracted from designated reference data tables. Reference data defined in scripts can be validated against the corresponding reference data table definition to ensure the data is of the correct data type and length, etc. Errors can be reported.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings:

FIG. 1 illustrates an example of a system 100 that defines and deploys reference data to a database in accordance with aspects of the subject matter disclosed herein;

FIG. 2 illustrates an example of a method 200 that defines and deploys reference data to a database in accordance with aspects of the subject matter disclosed herein;

FIG. 3 is a block diagram of an example of a computing environment in accordance with aspects of the subject matter disclosed herein; and

FIG. 4 is a block diagram of an example of an integrated development environment in accordance with aspects of the subject matter disclosed herein.

### DETAILED DESCRIPTION

### Overview

Data such as reference data can be defined declaratively but can be deployed imperatively allowing the reference data to be deployed to both new and existing databases. Reference data can be defined in any suitable declarative format including but not limited to comma-separated lists, in JSON, in key/value pairs, or in scripts (e.g., SQL or T-SQL scripts). The reference data can be defined along with the corresponding database artifact (e.g., table, view, etc.) definition scripts, commonly referred to collectively as the database schema. The reference data definition can thus be treated as a part of the database schema using existing software source code management systems.

By including declarative reference data definitions in the scope of a schema comparison of databases or other representations of a database schema (e.g. SQL scripts that create a database), changes to reference data values can be reported along with other schema changes. A dependency graph can be constructed to enable source code analysis (e.g., to enable refactoring, finding references, and so on). Imperative scripts prohibit this kind of analysis because an imperative script represents a potentially incomplete set of changes rather than a complete data definition.

On deployment of a database schema that includes a declarative representation of reference data to an existing database, any current data in reference data tables can be inspected and appropriate imperative data scripts (which may include insert, update and delete statements) can be generated and included in the deployment to ensure the database is updated efficiently (e.g., only the rows that need to be updated are updated instead of passing in the entire dataset to a merge statement in which case the entire dataset is processed even if there are no changes) and correctly (e.g., in the correct order). Use of merge scripts can be avoided.

The generated script can take account of data dependencies derived from foreign key constraints that may be defined between tables, and that require that the data is inserted or updated in a specific sequence. Support for open and closed reference data sets can be provided. A reference table can be annotated as closed or open. If the reference table is designated as closed, the generated script can delete any values present in the database that are not included in the declarative reference data definition. If the reference table is designated as open, the script can make sure the defined values exist, creating any that are missing, without deleting additional values.

Reference data can be included in schema comparison. Schema differencing can be used to identify differences in database definitions or the difference between a database definition in source code and a deployed database; by defining reference data values declaratively and including them in the scope of schema comparison, changes in reference data values can be identified between different versions of a schema; this can highlight the presence of missing, additional or changed data values.

The deployed database can be used as a source in a comparison by designating the tables in the deployed database that are reference data tables. Reference data can be extracted from specified reference data tables. By designating and annotating tables as reference data tables, data values can be extracted along with the corresponding table schema and can be included in generated scripts that can be used to recreate the database, or that can be modified offline and re-deployed to the same or a different database, including the reference data values.

Reference data defined in scripts can be validated against the corresponding table definition to detect reference data integrity issues such as but not limited to incorrect data type and length. Errors can be reported.

### Declarative Support for Reference Data in Relational Databases

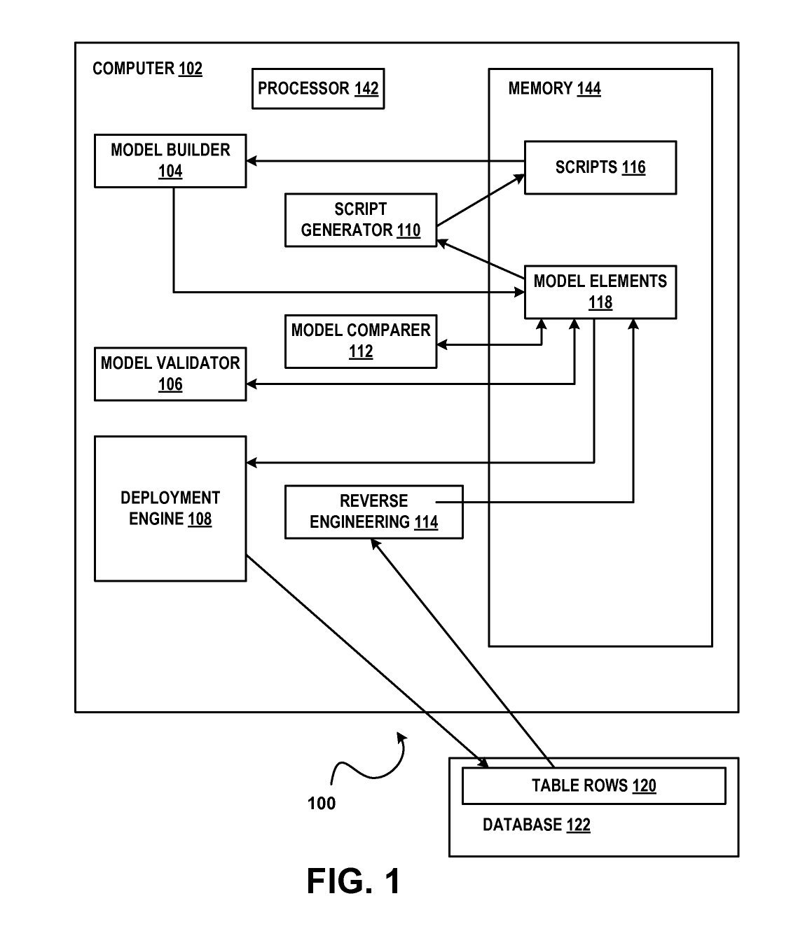

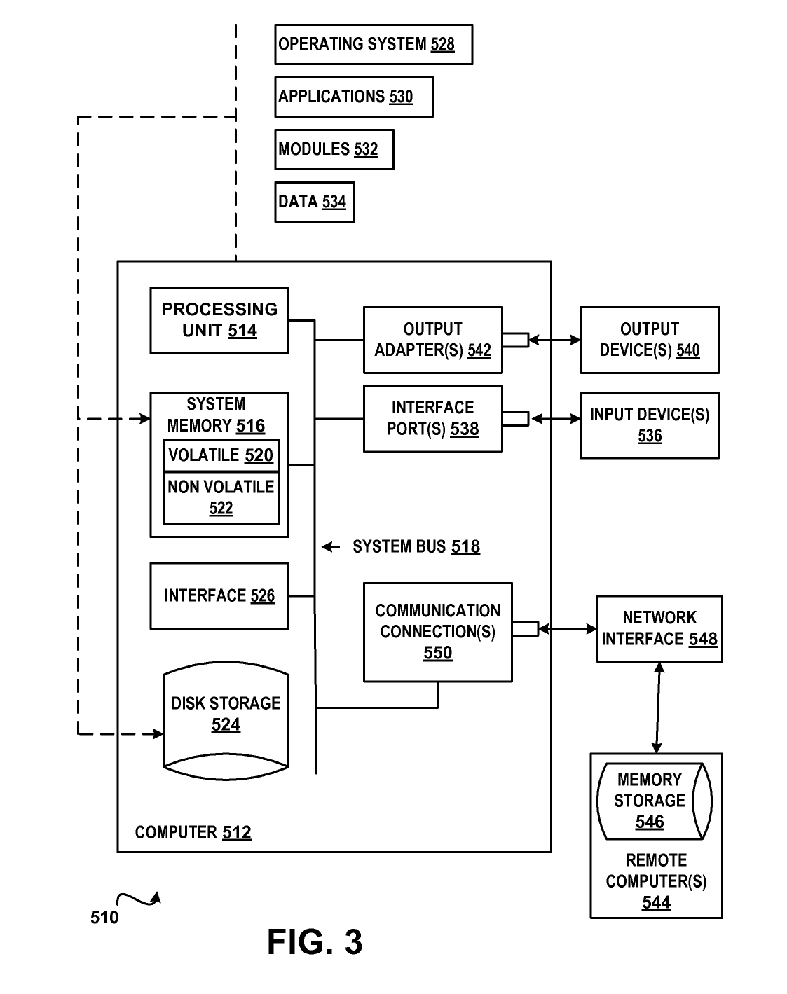

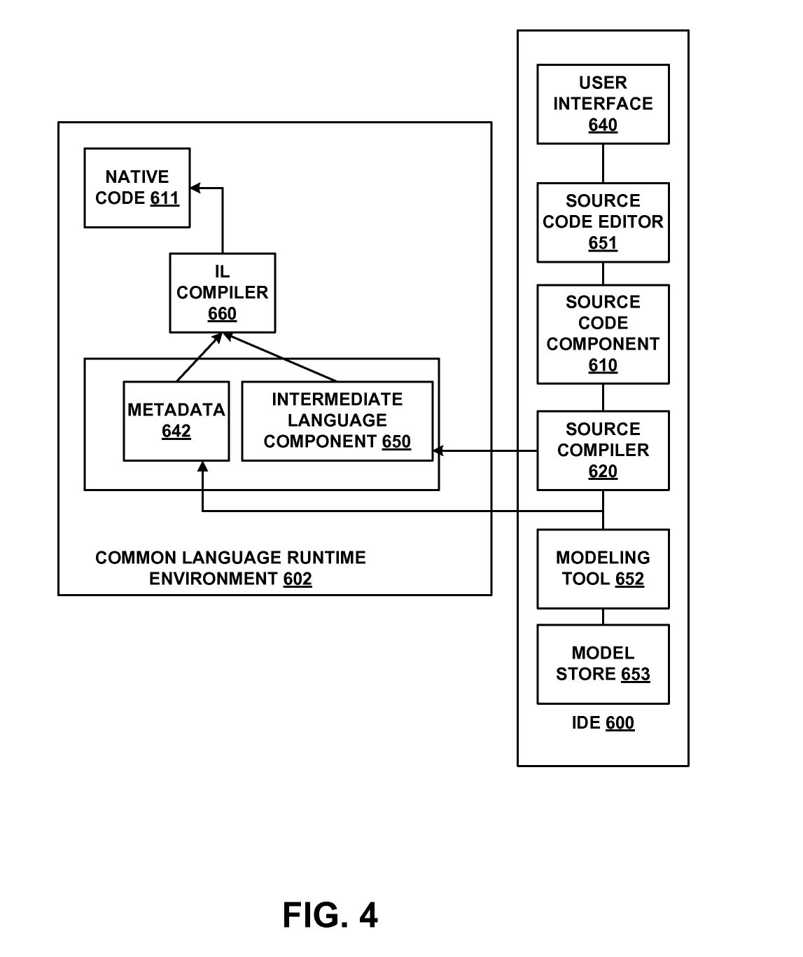

FIG. 1 illustrates an example of a system 100 that defines and deploys reference data to a database in accordance with aspects of the subject matter disclosed herein. All or portions of system 100 may reside on one or more computers such as the computers described below with respect to FIG. 3. System 100 may execute on a software development computer such as the software development computer described with respect to FIG. 4. System 100 or portions thereof may execute within an IDE or may execute outside of an IDE. The IDE can be an IDE such as the one described with respect to FIG. 4 or can be any other IDE that supports a native language. All or portions of system 100 may be implemented as a plug-in or add-on.

System 100 may include one or more computers or computing devices such as a computer 102 comprising: one or more processors such as processor 142, etc., a memory such as memory 144, and any combination of: one or more program modules or components such as model builder 104, model validator 106, database deployment engine 108, script generator 110, model comparer 112, and/or reverse engineering module 114. System 100 may also include other components (not shown) known in the arts. Reference data can be used by references as the subject of referential integrity constraints within the database. Correct reference data enables a user to add other records/values that refer to the reference data. Reference data can be defined in any suitable declarative format including but not limited to comma-separated lists, in JSON, in key/value pairs, or in the form of one or more scripts such as script 116. In accordance with aspects of the subject matter described herein, script 116 can be T-SQL INSERT statements. Script 116 can be interpreted by the model builder 104. Model builder 104 can construct corresponding reference data model elements (e.g., model elements 118) from the script 116. The reference data model elements, in accordance with aspects of the subject matter described herein, can be an in-memory representation of the reference data. The reference data model elements can be validated by the model validator 106 which can check constraint violations such as unsupported data types and the absence of keys. Violations can be reported as model element construction errors.

The deployment engine 108 can insert the reference data into hosting tables by using the data stored in the model elements. The reverse engineering module 114 can generate the reference data model elements by extracting reference data from the hosting tables previously tagged as reference data tables. The script generator 110 can take the reference data model elements and can generate scripts such as script 116 (e.g., T-SQL INSERT statements). The model comparer 112 can receive two sets of model elements and can generate therefrom a comparison result that details the differences between the two sets. The comparison result can be consumed by a schema comparer (not shown) that visualizes the differences of two sets of data. The comparison result can be consumed by the deployment engine 108 to perform the incremental deploy on reference data content such as table rows 120 of database 122, in which only the changed reference data is changed.

### Model Building

The scripts such as script 116 (e.g., T-SQL statements defining reference data) can be interpreted by a model builder such as model builder 104 to create corresponding model elements such as model elements 118 (e.g., reference data model elements) inside a model (not shown) to represent the reference data. Model elements for the reference data can be validated by a model validator such as model validator 106 against specifically-designed rules for the reference data. The rules can include data validation constraints that can be validated at design time or at runtime (e.g., by the SQL engine). Some rules (data type checks, range checks) can be validated by the system, while other rules can be applied by the database engine at runtime on data insert/update operations). Errors detected during reference data model element validation can be reported.

### Deployment

Existing reference data from a target database can be imported into a temporary model (a first model, Model 1, not shown) using a reverse engineering module or component such as reverse engineering module 114. The model (a second model, Model 2, not shown) that stores the reference data to be deployed can be compared with the temporary model using a model comparer such as model comparer 112. A deployment engine such as deployment engine 108 can generate scripts (e.g., T-SQL scripts such as script 116) based on the delta generated by the model comparison. The generated scripts can include statements that direct only the operations needed to place the reference data into a desired state in a target database (e.g., a relational database). For example, the generated script can direct insertion of reference data values or sets of values of reference data into the target database and/or can include statements that direct the updating of particular values or sets of values of reference data and/or can include statements that direct the deletion of particular values or sets of values of reference data.

### Model Comparison

A comparison between any combination of database, project (offline scripts) and/or snapshots including schema and data in a persisted (e.g., scripted) form can be performed. For example, existing reference data from the database 122 can be imported into the temporary model (first model, Model 1) using the reverse engineering module 114. A second model (Model 2) can store reference data from a project can be compared with the temporary model by the model comparer 112. The difference or delta between the two models generated as described above can be visualized by a schema comparer (not shown) which may comprise a portion of the model comparer 112 or which can be separate from the model comparer.

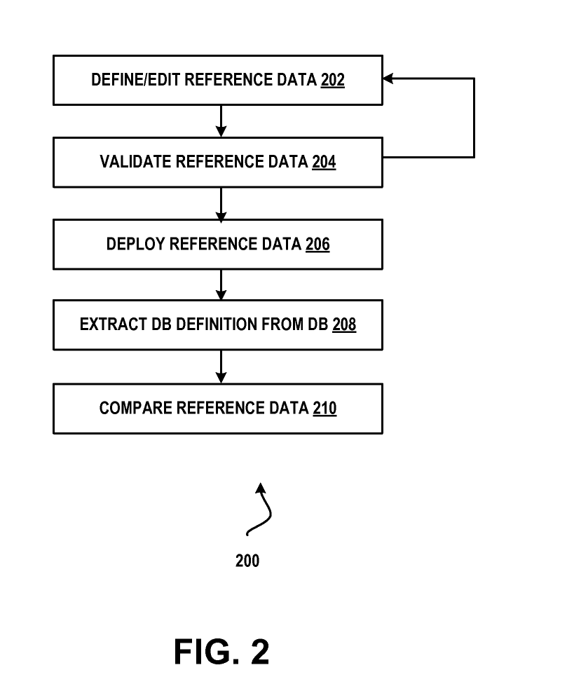

FIG. 2 illustrates a method 200 that defines and deploys reference data to a database in accordance with aspects of the subject matter disclosed herein. The method described in FIG. 2 can be practiced by a system such as but not limited to the one described with respect to FIG. 1. While method 200 describes a series of acts that are performed in a sequence, it is to be understood that method 200 is not limited by the order of the sequence. For instance, some acts may occur in a different order than that described. In addition, an act may occur concurrently with another act. In some instances, not all acts may be performed.

At 202 reference data can be defined and edited. Reference data values can be described declaratively using script statements such as T-SQL insert statements as part of the definition of the database, such as by definition of a schema. In accordance with aspects of the subject matter disclosed herein, the schema can be defined using DDL (data definition language) statements. During development, a user such as a developer can add, remove or modify insert statements directly. Reference data tables can be defined with explicit keys so that the reference data declaration is idempotent, guaranteeing that the reference data defined in the schema will result in the same data records being instantiated in any deployment of the schema. An idempotent data declaration also ensures that relationships can be defined between data values. For example, a primary key can be defined for a reference data set comprising United States states, and the primary key for the states can be used to define a foreign key for a United States cities table. Reference data tables can be designated as open or closed. The deployment of the reference data tables can influence the deployment process. Data editing tools can allow direct data editing of reference data values included in the schema. For example, a grid like tool can be used where each row in the tool corresponds to a data row in an insert statement.

At 204 reference data can be validated. As part of the schema development process and prior to deploying a schema, reference data can be validated to ensure the reference data is syntactically and semantically valid. For example, reference data validation can include verifying data definitions, that values are provided for all non-nullable columns, that values have the correct data type, and, where appropriate, the correct length. Other validations can also be performed on the data prior to deployment. The ability to perform validations can be extensible.

At 206 reference data can be deployed. Validated data definitions can be input to a data definition (e.g., schema) deployment process. The data definition deployment process can generate a script that includes DML (data manipulation language) statements that direct the representation of the reference data in the database. The generated script can contain any combination of create, insert and/or delete statements. The script that is generated for a particular deployment can depend on the state of any data in the target database. For example, a new deployment typically includes only Insert statements. If a reference table is designated as closed, the generated script can include delete statements that remove any data entries that exist in the database that are not in the definition being deployed. The generated script can honor any dependencies that exist in the database schema among reference data tables and among the data values that require data rows to be inserted in a specific sequence. The overall result is an efficient data manipulation script that ensures the database includes the reference data. The script can be executed after any other schema changes have been made as an integral part of deploying the database definition.

At 208 a database definition such as but not limited to a schema that includes the data definition of the reference data can be extracted from a database. A schema in the form of a script can be extracted from the database in order to work on the design of a database offline. When extracting a schema from an existing database, reference data can be extracted from designated reference tables to create the appropriate insert script. The resulting script can thereafter be treated as described above and may be used to update the source database or to deploy to a different database. An annotation mechanism can be provided by which reference tables are identified as such either in the database installation or as input to the extraction process. This process and the declarative manner in which reference data is held in the schema allows an offline schema to be repeatedly synchronized to the state of a database. (Synchronization of an offline schema with the state of a database can be implemented by comparing reference data as described elsewhere.

At 210 reference data can be compared. By including reference data in a declarative form as part of the schema, schemas of existing databases and schemas under development can be compared interchangeably and any differences in the reference data in the databases can be highlighted. It is possible that the only difference between two schemas results from differences in their reference data content. Schema comparison tools can optionally detect and report on differences between reference data values.

### Example of a Suitable Computing Environment

In order to provide context for various aspects of the subject matter disclosed herein, FIG. 3 and the following discussion are intended to provide a brief general description of a suitable computing environment 510 in which various embodiments of the subject matter disclosed herein may be implemented. While the subject matter disclosed herein is described in the general context of computer-executable instructions, such as program modules, executed by one or more computers or other computing devices, those skilled in the art will recognize that portions of the subject matter disclosed herein can also be implemented in combination with other program modules and/or a combination of hardware and software. Generally, program modules include routines, programs, objects, physical artifacts, data structures, etc. that perform particular tasks or implement particular data types. Typically, the functionality of the program modules may be combined or distributed as desired in various embodiments. The computing environment 510 is only one example of a suitable operating environment and is not intended to limit the scope of use or functionality of the subject matter disclosed herein.

With reference to FIG. 3, a computing device in the form of a computer 512 is described. Computer 512 may include at least one processing unit 514, a system memory 516, and a system bus 518. The at least one processing unit 514 can execute instructions that are stored in a memory such as but not limited to system memory 516. The processing unit 514 can be any of various available processors. For example, the processing unit 514 can be a GPU. The instructions can be instructions for implementing functionality carried out by one or more components or modules discussed above or instructions for implementing one or more of the methods described above. Dual microprocessors and other multiprocessor architectures also can be employed as the processing unit 514. The computer 512 may be used in a system that supports rendering graphics on a display screen. In another example, at least a portion of the computing device can be used in a system that comprises a graphical processing unit. The system memory 516 may include volatile memory 520 and nonvolatile memory 522. Nonvolatile memory 522 can include read only memory (ROM), programmable ROM (PROM), electrically programmable ROM (EPROM) or flash memory. Volatile memory 520 may include random access memory (RAM) which may act as external cache memory. The system bus 518 couples system physical artifacts including the system memory 516 to the processing unit 514. The system bus 518 can be any of several types including a memory bus, memory controller, peripheral bus, external bus, or local bus and may use any variety of available bus architectures. Computer 512 may include a data store accessible by the processing unit 514 by way of the system bus 518. The data store may include executable instructions, 3D models, materials, textures and so on for graphics rendering.

Computer 512 typically includes a variety of computer readable media such as volatile and nonvolatile media, removable and non-removable media. Computer storage media may be implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other transitory or non-transitory medium which can be used to store the desired information and which can be accessed by computer 512.

It will be appreciated that FIG. 3 describes software that can act as an intermediary between users and computer resources. This software may include an operating system 528 which can be stored on disk storage 524, and which can allocate resources of the computer 512. Disk storage 524 may be a hard disk drive connected to the system bus 518 through a non-removable memory interface such as interface 526. System applications 530 take advantage of the management of resources by operating system 528 through program modules 532 and program data 534 stored either in system memory 516 or on disk storage 524. It will be appreciated that computers can be implemented with various operating systems or combinations of operating systems.

A user can enter commands or information into the computer 512 through an input device(s) 536. Input devices 536 include but are not limited to a pointing device such as a mouse, trackball, stylus, touch pad, keyboard, microphone, and the like. These and other input devices connect to the processing unit 514 through the system bus 518 via interface port(s) 538. An interface port(s) 538 may represent a serial port, parallel port, universal serial bus (USB) and the like. Output devices(s) 540 may use the same type of ports as do the input devices. Output adapter 542 is provided to illustrate that there are some output devices 540 like monitors, speakers and printers that require particular adapters. Output adapters 542 include but are not limited to video and sound cards that provide a connection between the output device 540 and the system bus 518. Other devices and/or systems or devices such as remote computer(s) 544 may provide both input and output capabilities.

Computer 512 can operate in a networked environment using logical connections to one or more remote computers, such as a remote computer(s) 544. The remote computer 544 can be a personal computer, a server, a router, a network PC, a peer device or other common network node, and typically includes many or all of the elements described above relative to the computer 512, although only a memory storage device 546 has been illustrated in FIG. 3. Remote computer(s) 544 can be logically connected via communication connection(s) 550. Network interface 548 encompasses communication networks such as local area networks (LANs) and wide area networks (WANs) but may also include other networks. Communication connection(s) 550 refers to the hardware/software employed to connect the network interface 548 to the bus 518. Communication connection(s) 550 may be internal to or external to computer 512 and include internal and external technologies such as modems (telephone, cable, DSL and wireless) and ISDN adapters, Ethernet cards and so on.

It will be appreciated that the network connections shown are examples only and other means of establishing a communications link between the computers may be used. One of ordinary skill in the art can appreciate that a computer 512 or other client device can be deployed as part of a computer network. In this regard, the subject matter disclosed herein may pertain to any computer system having any number of memory or storage units, and any number of applications and processes occurring across any number of storage units or volumes. Aspects of the subject matter disclosed herein may apply to an environment with server computers and client computers deployed in a network environment, having remote or local storage. Aspects of the subject matter disclosed herein may also apply to a standalone computing device, having programming language functionality, interpretation and execution capabilities.

FIG. 4 illustrates an integrated development environment (IDE) 600 and Common Language Runtime Environment 602. An IDE 600 may allow a user (e.g., developer, programmer, designer, coder, etc.) to design, code, compile, test, run, edit, debug or build a program, set of programs, web sites, web applications, and web services in a computer system. Software programs can include source code (component 610), created in one or more source code languages (e.g., Visual Basic, Visual J#, C++. C#, J#, Java Script, APL, COBOL, Pascal, Eiffel, Haskell, ML, Oberon, Perl, Python, Scheme, Smalltalk and the like). The IDE 600 may provide a native code development environment or may provide a managed code development that runs on a virtual machine or may provide a combination thereof. The IDE 600 may provide a managed code development environment using the .NET framework. An intermediate language component 650 may be created from the source code component 610 and the native code component 611 using a language specific source compiler 620 and the native code component 611 (e.g., machine executable instructions) is created from the intermediate language component 650 using the intermediate language compiler 660 (e.g. just-in-time (JIT) compiler), when the application is executed. That is, when an IL application is executed, it is compiled while being executed into the appropriate machine language for the platform it is being executed on, thereby making code portable across several platforms. Alternatively, in other embodiments, programs may be compiled to native code machine language (not shown) appropriate for its intended platform.

A user can create and/or edit the source code component according to known software programming techniques and the specific logical and syntactical rules associated with a particular source language via a user interface 640 and a source code editor 651 in the IDE 600. Thereafter, the source code component 610 can be compiled via a source compiler 620, whereby an intermediate language representation of the program may be created, such as assembly 630. The assembly 630 may comprise the intermediate language component 650 and metadata 642. Application designs may be able to be validated before deployment.

The various techniques described herein may be implemented in connection with hardware or software or, where appropriate, with a combination of both. Thus, the methods and apparatus described herein, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing aspects of the subject matter disclosed herein. As used herein, the term “machine-readable medium” shall be taken to exclude any mechanism that provides (i.e., stores and/or transmits) any form of propagated signals. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects, e.g., through the use of a data processing API or the like, may be implemented in a high level procedural or object oriented programming language to communicate with a computer system. However, the program(s) can be implemented in assembly or machine language, if desired. In any case, the language may be a compiled or interpreted language, and combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system comprising:
at least one processor of a computing device;
a memory of the computing device; and
at least one module loaded into the memory causing the at least one processor to:
declaratively define data for a database artifact for a database; and
deploy the data to the database imperatively.

2. The system of claim 1, further comprising:
at least one module loaded into the memory causing the at least one processor to:
designate the database artifact as closed, such that defined values present in the database artifact but not included in a schema for the database artifact are deleted from the database.

3. The system of claim 1, further comprising:
at least one module loaded into the memory causing the at least one processor to:
designate the database artifact as open, such that defined values present in the database artifact but not included in a schema for the database artifact are not deleted from the database.

4. The system of claim 1, further comprising:
at least one module comprising a schema comparer that is loaded into the memory causing the at least one processor to:
receive a comparison result from a model comparer that compares two sets of data model elements and generates the comparison result that lists differences between the two sets.

5. The system of claim 1, further comprising:
at least one module comprising a deployment engine that is loaded into the memory causing the at least one processor to:
perform an incremental deploy by creating imperative scripts and executing the created imperative scripts, the incremental deploy only updating changed data.

6. The system of claim 1, further comprising:
at least one module comprising a reverse engineering module that is loaded into the memory causing the at least one processor to:
generate data model elements by extracting data from hosting tables.

7. The system of claim 5, further comprising:
at least one module comprising a model builder that is loaded into the memory causing the at least one processor to:
construct corresponding data model elements from a reference data definition for the database.

8. A method comprising:
defining reference data in a reference data definition declaratively as part of declaratively defining a database schema for a database; and
deploying the reference data to the database imperatively by generating a script directing representation of the reference data in reference data tables in the database, the generated script depending on the state of the reference data in the database.

9. The method of claim 8, further comprising:
validating the reference data as part of a schema development process.

10. The method of claim 8, further comprising:
designating a reference data table for the reference data as closed; and
removing reference data entries in the database not in the reference data definition.

11. The method of claim 10, further comprising:
honoring dependencies in the database schema among reference data tables and among the data values so that data rows are inserted in the database in a specific sequence.

12. The method of claim 9, further comprising:
designating a reference data table for the reference data as open; and
failing to delete reference data entries in the database not in the reference data definition.

13. The method of claim 8, further comprising:
extracting a reference data schema for a data reference table from the database, the schema comprising a table definition script and a data definition script.

14. The method of claim 8, further comprising:
comparing a reference data schema of an existing database and a reference data schema of a database under development, wherein the comparison identifies differences in reference data values.

15. A computer-readable storage medium comprising computer-executable instructions which when executed cause at least one processor of a computing device to:
define reference data for a database declaratively as part of declaratively defining a schema;
generate an imperative script, the imperative script used to deploy the database;
validate the imperative script against a corresponding reference data table definition; and
incrementally deploy the reference data to the database imperatively, only updating changed reference data.

16. The computer-readable storage medium of claim 15, comprising further computer-executable instructions, which when executed cause at least one processor to:
designate a reference data table for the reference data as closed; and
remove reference data entries in the database not in the reference data definition.

17. The computer-readable storage medium of claim 16, comprising further computer-executable instructions, which when executed cause at least one processor to:
designate a reference data table for the reference data as open; and
fail to delete reference data entries in the database not in the reference data definition.

18. The computer-readable storage medium of claim 15, comprising further computer-executable instructions, which when executed cause at least one processor to:
extract a schema for a data reference table from the database; and
extract the reference data from the database in a declarative format.

19. The computer-readable storage medium of claim 15, comprising further computer-executable instructions, which when executed cause at least one processor to:
compare a reference data schema of an existing database and a reference data schema of a database under development, wherein the comparison identifies differences in reference data values.

20. The computer-readable storage medium of claim 15, comprising further computer-executable instructions, which when executed cause at least one processor to:
honor dependencies in the database schema among reference data tables and among the data values that require data rows to be inserted in a specific sequence.
